(19) United States
(12) Patent Application Publication
(10) Pub. No.: US 2014/0097792 A1
(43) Pub. Date: Apr. 10, 2014

(54) ELECTRIC VEHICLE RECHARGING AND OR SUPPLYING ELECTRICAL POWER

(71) Applicant: UT-Battelle, LLC, Oak Ridge, TN (US)

(72) Inventor: Gui-Jia Su, Oak Ridge, TN (US)

(73) Assignee: UT-Battelle, LLC, Oak Ridge, TN (US)

(21) Appl. No.: 14/043,557

(22) Filed: Oct. 1, 2013

Related U.S. Application Data
(60) Provisional application No. 61/709,529, filed on Oct. 4, 2012.

(51) Int. Cl. B60L 11/18

(52) U.S. Cl. CPC B60L 11/182
USPC 320/108

(57) ABSTRACT

An electrical vehicle system recharges and sources electrical power in an electric vehicle. The electrical vehicle system includes a first drive and second drive unit electrically connected to a direct current bus. A converting circuit is serially connected to the first drive unit and the second drive unit and is electrically connected to a high voltage energy source and a low voltage energy source. The converting circuit electrically connects the high voltage energy source and the low voltage energy source through an inductive connection.

### PRIORITY CLAIM

This application claims the benefit of priority from U.S. Provisional Application No. 61/709,529 filed Oct. 4, 2012, under attorney docket number 2931.0, entitled “Electric Vehicle Recharging and or Supplying Electrical Power”, which is incorporated herein by reference.

### STATEMENT REGARDING FEDERALLY SPONSORED RESEARCH AND DEVELOPMENT

The invention was made with United States government support under Contract No. DE-ACO5-000R22725 awarded by the United States Department of Energy. The United States government has certain rights in the invention.

### BACKGROUND

1. Technical Field

This disclosure relates to electric vehicle systems and methods for charging energy storage devices; and further relates to supplying power to external loads through electric vehicles and hybrid vehicles.

2. Related Art

Hybrid electric vehicles may optimize the energy efficiency of an internal combustion engine and capture a portion of the kinetic energy generated through dynamic braking. In practice, some batteries enable hybrid electric vehicles to travel only limited driving distances. Plug-in hybrids may use larger capacity batteries to enable longer driving ranges. However, the larger the capacity of the batteries the longer these batteries may need to be recharged.

While it is desirable to use larger capacity batteries in hybrid electric vehicles, when fossil fueled energy plants supply the power to recharge the batteries, the charging of the batteries may cause the release of more pollutants. To reduce pollution, cleaner sources of power may be used, vehicles connections to external charging sources may need to be minimized, and electric vehicle's use of combustion engines may need to be minimized.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an electric drive system of a hybrid electric vehicle.

FIG. 2 is an alternative electric drive system of a hybrid electric vehicle.

FIG. 3 is a second alternative electric drive system of a hybrid electric vehicle.

FIG. 4 is a third alternative electric drive system of a hybrid electric vehicle.

### DETAILED DESCRIPTION OF THE PREFERRED EMBODIMENTS

A drive system includes a large capacity storage device that stores sufficient energy to enable an electric vehicle or hybrid electric vehicle to drive extended ranges. The ranges may allow vehicles to drive long distances without relying on a second prime moving source such as the vehicle's internal combustion engine for a significant distance. Some electric drive systems may function as mobile generators too that supply external power on demand for remote use. The electric drive systems may integrate battery charging systems with the drive units to minimize parts, which may increase reliability and reduces vehicle costs. Some systems isolate the devices that generate the vehicle's moving force from the power source (e.g., a local battery or external power source) to protect against electric shock, supress noise, and to block electric signal components from being transferred from one system or circuit to another. Electrical isolation such as galvanic isolation may enable some electronic drive systems to exceed safety requirements and couple multiple charging systems to one or more drive systems.

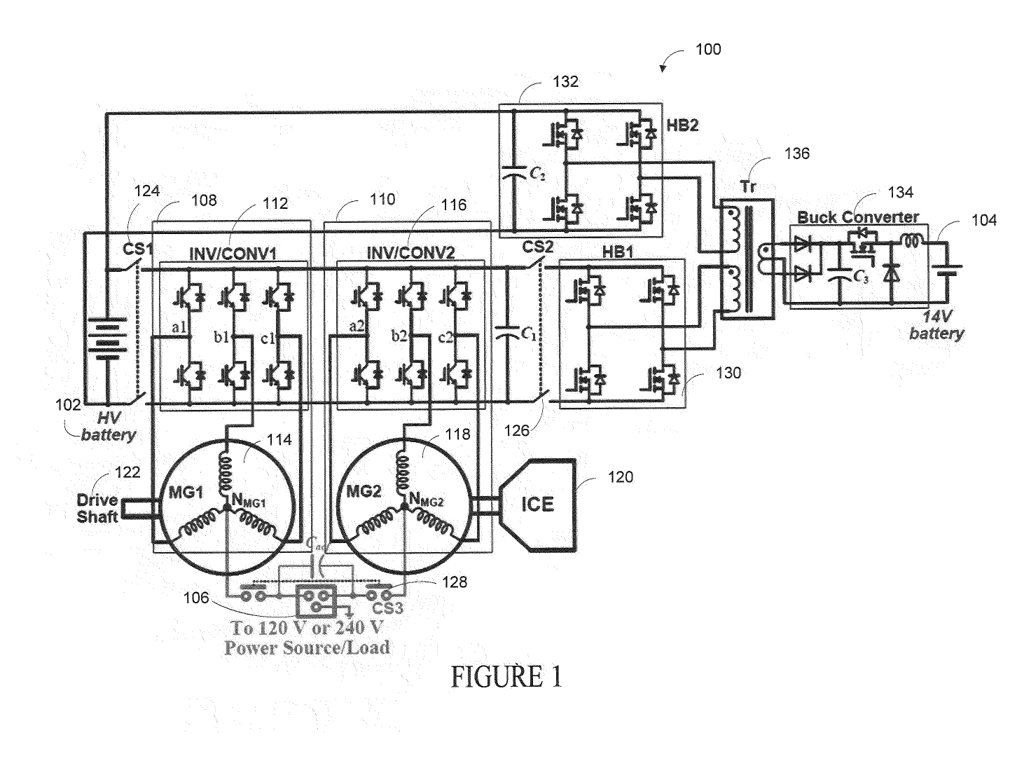

FIG. 1 is an electric drive system 100 of a hybrid electric vehicle. The electric drive system 100 includes multiple energy storage devices 102 and 104, an interface 106 and multiple drive units 108 and 110. In FIG. 1 the drive units 108 and 110 include an inverter/converter 112/116 and an electric drive assembly 114/118 shown as an electric motor. When the inverter/converter 112/116 functions as an inverter, the inverter/converter 112/116 “inverts” a direct current (dc) voltage into alternating power or an alternating current (ac) voltage that may be used to control the speed or torque that the motor delivers to a drive shaft. When the inverter/converter 112/116 functions as a converter the alternating current created by the rotary force delivered by a moving force (such as the rotary force produced by an internal combustion engine or ICE 120) is converted into a dc current. In vehicles, multiple drive units may deliver power and speed/torque to one or more wheels. For example, five or less drive units may support four-wheel drive vehicles; just as three or less drive units may support two-wheel drive vehicles.

Hybrid electric vehicles may include coupling devices to transmit the rotary force generated by a moving source such as the ICE 120 and one or more electric motors to a rotary drive shaft. In FIG. 1, an electric motor drive system 100 includes a high voltage and high capacity energy storage device 102 and a first electric drive assembly (shown as MG1 114) that delivers torque to a drive shaft 122, the transmission, the powertrain, and the wheels. The vehicle may be propelled by the first electric drive assembly (MG1 114), by the ICE 120, or by a combination.

In FIG. 1, the first electric drive assembly (MG1 114) may recharge multiple energy storage devices 102 and 104 (two are shown: a high voltage battery having a nominal voltage about or above 200 Volts or HV battery and an optional low voltage battery or LV battery having a nominal voltage about of above about 12 V) and serves as the prime moving force for the vehicle. When enabled, the first electric drive assembly (MG1 114) also performs the vehicle's reverse function.

The second electric drive assembly (shown as MG2 118) operates to recharge multiple energy storage devices 102 and 104 and may function as a starter motor for the ICE 120. An electronic control unit (ECU), electronic control module (ECM), powertrain control module (PCM), etc. may control the operation of the electric drive system 100.

Both electric drive assemblies (MG1 114 and MG2 118) are three-phase permanent magnetic devices or induction motors that provide mechanical torque when driven by an alternating current source (ac source) or provide an ac output (i.e., act as a generator) when rotated by an outside or remote source. The remote source may comprise the ICE 120, one or more of the vehicle's wheel rotation, the rotary motion of one or more drive shafts, etc. In a four wheel drive vehicle, when the transfer case is in two wheel drive mode, the outside or remote source may comprise only the front or rear drive shaft because the front or rear drive shaft may not spin even though all the wheels may be moving. When engaged in four wheel drive, the outside or remote source may comprise the front and rear drive shafts.

In FIG. 1, the HV energy storage device 102 and electric drive assemblies 114 and 118 are electrically connected to a common dc bus. The electric drive system 100 includes multiple sets of electronically controlled double pole single throw (DPST) switches (CS1124 and CS2 126), and a charging converter or interface 106. Each drive unit 108 and 110 employs an inverter/converter 112/116 (shown as INV/CONV) and an electric drive assembly (MG1 114 or MG2 118), whose stator windings are electrically bundled together at one end to form a neutral point (NMG) of the electric drive assemblies while the other ends are electrically connected to the inverter/converter 112/116. One electric drive assembly (MG2 118) is coupled to the ICE 120 through a mechanical transmission and drive shaft while the other electric drive assembly (MG1 114) is directly coupled to the drive shaft. The neutral points of the electric drive assemblies (MG1 114 and MG2 118) are electrically coupled to the charging interface 106 through a third set of electronically controlled DPST switches (CS3 128); with each neutral node being electrically connected to the charging interface 106. The charging interface 106 may comprise a charging socket that selectively connects a remote charging source to the electric drive system 100. The charging socket may receive power from a remote source that charges the energy storage devices 102 and 104, or may deliver power to remote loads. In some electric drive systems, a filter capacitor (Caf) positioned across the charging interface 106 filters out switching harmonics.

In some electric drive systems, a converting circuit enables a voltage to be applied across a load in either direction. The converting circuit in FIG. 1 comprises a plurality of switching circuits (e.g., four switches per circuit) that enable a voltage to be applied across a load in a plurality of directions. As shown, H-bridges (HB1 130 and HB2 132) are used that first converts dc to ac and then converts the ac to dc when the electric drive systems are in a charging mode. The converting circuit is electrically connected to an optional buck converter 134 through a high frequency isolation transformer (Tr) 136. The Tr 136 provides galvanic isolation for the HV and/or optional LV storage devices 102 and 104. When charging, the optional buck converter 134 charges the optional LV storage device 104, which may power the vehicle's low voltage accessory loads that include the vehicle's instrumentation and cabin lighting, for example.

An automated electronic control mode selection made by the ECU, ECM, PCM, etc. for example, may select the electric drive system's 100 operating state. In the propulsion mode, the electric drive system 100 enables a propulsion force for driving the vehicle. In this mode, electronically controlled DPST switch CS1 124 is closed and DPST CS2 126 and CS3 are open connecting the HV energy storage device 102 to drive units 108 and 110 while disconnecting the drive units 108 and 110 from HB1 130 and the charging interface 106. Drive units 108 and 110 may control the speed and/or torque of the respective electric drive assemblies (MG1 114 and MG2 118) by delivering a modulated three phase power to the electric drive assemblies (MG1 114 and MG2 118). In the propulsion mode the charging circuit comprised of HB2 132 and the optional buck converter 134 may charge the optional LV energy storage device 104 from the HV energy storage device 102.

In the charging mode, the electric drive system 100 enables the charging of the HV and/or the optional LV energy storage devices 102 and 104. In this mode, electronically controlled DPST switch CS1 124 is open and DPST CS2 126 and DPST CS3 126 are closed; disconnecting the HV energy storage device 102 from the drive units 108 and 110 while connecting the drive units 108 and 110 to the converting circuit (HB1 130 and HB2 132) and the charging interface 106. All of the switch legs in each inverter/converter 112 or 116 of each drive unit 108 and 110 collectively operate as a single switch leg and the electric drive assemblies (MG1 114 and MG2 118) operate as an inductor with substantially zero sequence impedance. Together, the drive units 108 and 110 form a single-phase converter that regulates the dc bus voltage that is drawn from the external source.

In the charging mode, the H-bridge HB1 130 operates off the de bus and supplies a high frequency ac voltage to HB2 132 through the primary of the high frequency isolation transformer (Tr) 136. HB2 132 converts the high frequency ac voltage to a high voltage dc to charge the HV energy storage device 102. As needed, the optional buck converter 134 connected to the secondary of the high frequency isolation transformer (Tr) 136 converts the high frequency ac voltage generated by the H-bridge HB1 130 to a dc voltage to charge the optional LV energy storage device 104 shown as a 14V dc battery.

In the sourcing mode, the electric drive system 100 enables the HV energy storage device 104 to supply power to remote loads. In the sourcing mode, the power flow is reversed from that in the charging mode. The two drive units 108 and 110 form a single-phase inverter to supply remote loads through the charging interface 106. In the sourcing mode the electric drive assemblies (MG1 114 and MG2 118) are driven by the ICE 120 and/or drive shafts to generate power for supplying the dc bus and ac current to the remote loads through the charging interface 106. Alternatively, the converting circuit (HB1 130 and HB2 132) may supply or supplement the dc power from the HV energy storage device 102 to the two drive units 108 and 110, which converts the dc power to ac that is delivered to the charging interface 106 and the remote load. In some configurations, the optional buck converter 134 charges the optional LV energy storage device 136 when the electric drive system 100 supplies power to remote loads.

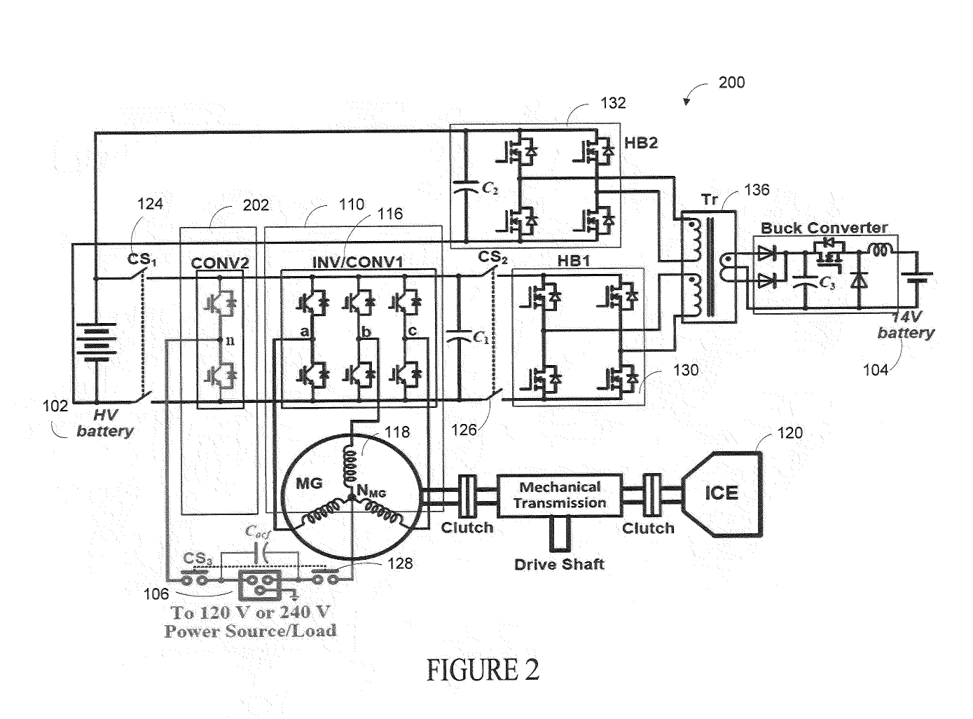

FIG. 2 is an alternative electric drive system 200 of a hybrid electric vehicle. In FIG. 2 a drive unit is replaced with a converter unit 202 (CONV2) comprising two switches that may comprise two insulated-gate bipolar transistors. In the propulsion mode, electronically controlled DPST switch CS1 124 is closed and DPST CS2 126 and CS3 128 are open connecting the HV energy storage device 102 to drive unit 110 while disconnecting the drive unit 110 from HB1 130 and the charging interface 106. Drive unit 110 may control the speed and/or torque of the electric drive assembly (MG2 118) by delivering a modulated three phase power to the electric drive assembly (MG 118).

In the charging mode of FIG. 2, electronically controlled DPST switch CS1 124 is open and DPST switches CS2 126 and CS3 128 are closed; disconnecting the HV energy storage device 102 from the drive unit 110 while connecting the drive unit 110 to the converting circuit (HB1 130 and HB2 132) and the charging interface 106. The H-bridge HB1 130 operates off the dc bus and supplies a high frequency ac voltage to HB2 132 through the primary of the high frequency isolation transformer (Tr) 136. HB2 132 converts the high frequency ac voltage to a high dc voltage to charge the HV energy storage device 102. As needed, the optional buck converter 134 electrically connected to the secondary of the high frequency isolation transformer (Tr) 136 converts the high frequency ac voltage generated by the H-bridge HB1 130 to a dc voltage to charge the optional LV energy storage device 104 shown as a 14V dc battery.

In the sourcing mode of FIG. 2, the electric drive assembly (MG 118) is driven by the ICE 120 and/or drive shafts to deliver dc power to the common dc bus and the converter unit (CONV2) 202 and the electric drive assembly (MG 118) delivers ac to the charging interface 106 and the remote load. Alternatively or in addition, the converting circuit (HB1 130 and HB2 132) may supply dc power from the HV energy storage device 102 to the drive unit 110 and the converter unit (CONV2), which delivers ac to the charging interface 106 and the remote load.

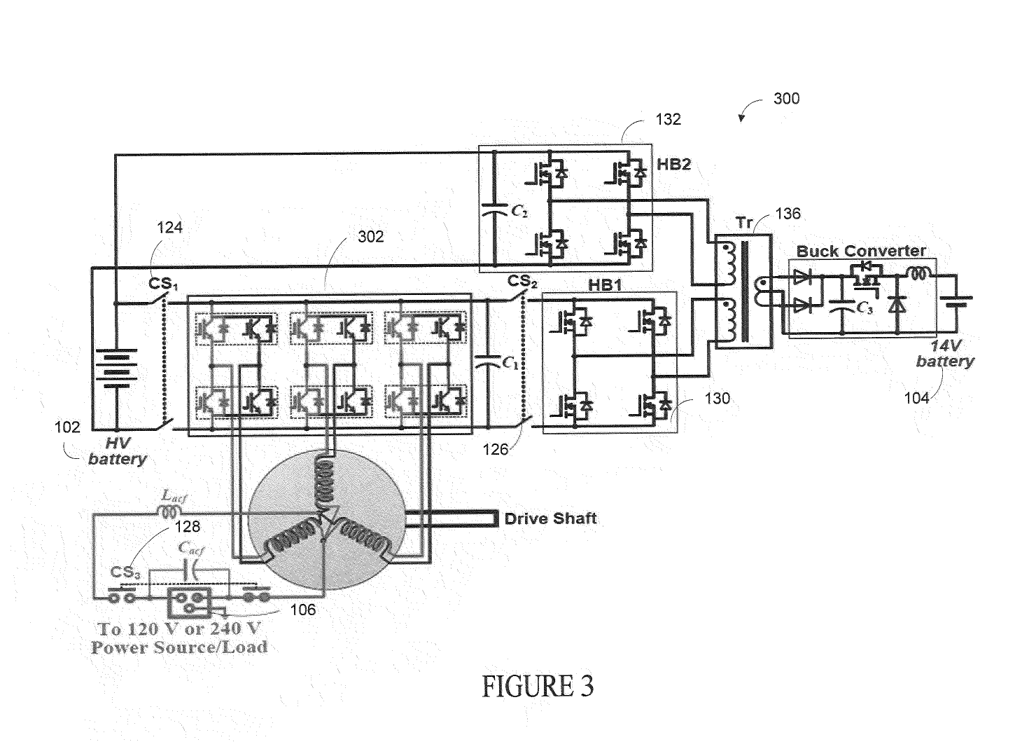

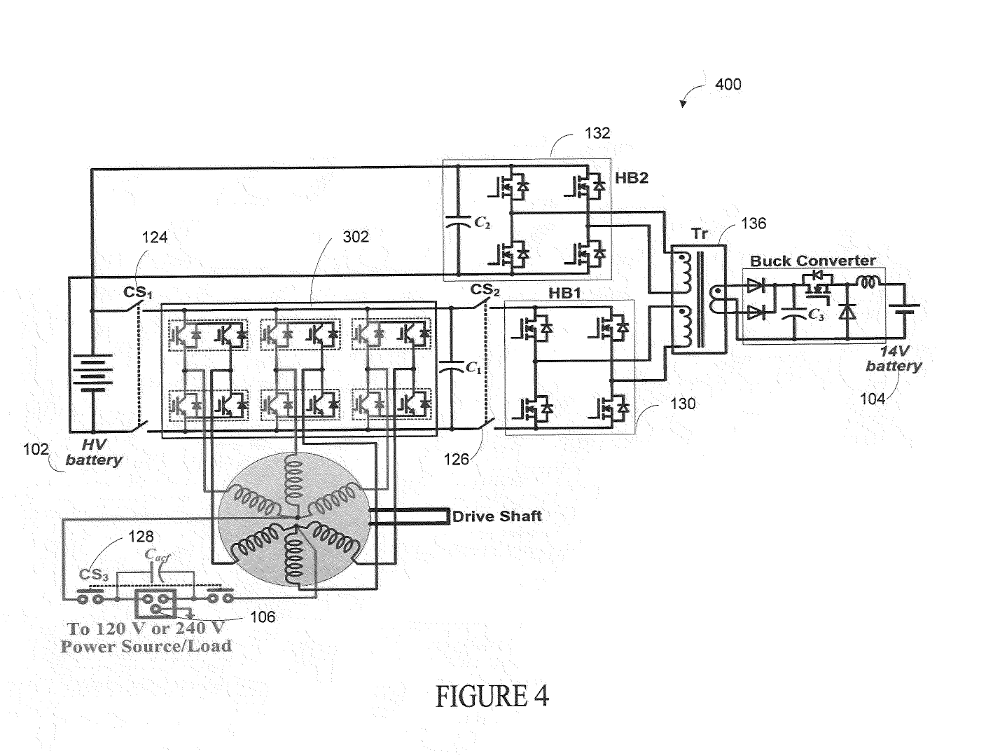

FIGS. 3 and 4 show two alternative electric drive systems that use a single electric drive assembly (e.g., in a motor/generator configuration) that includes two sets of three-phase stator windings. In FIG. 3, two sets of stator windings are collocated in the common slots within the circumference of the electric drive assembly's stator allowing the electric drive assembly 300 to function as a common mode inductor in the charging and sourcing modes. A filter inductor (Lacf) electrically connects the neutral points of the field windings to one of the node of the electronically controlled DPST switch CS3 128. In the FIG. 4, the two sets of field windings are located in different field slots of the stator allowing the electric drive assembly 400 to functions as a filter inductor in the charging and sourcing modes.

The operating modes and switching cycles of the DPSTs shown in electric drive assemblies 300 and 400 shown in FIGS. 3 and 4 operate like the electric drive assemblies 100 described in FIG. 1 above. In the propulsion mode, electronically controlled DPST switch CS1 124 is closed and CS2 126 and CS3 128 are open connecting the HV energy storage device 102 to the drive unit 302 while disconnecting the drive unit from HB1 130 and the charging interface 106. In the charging mode, electronically controlled DPST switch CS1 124 is open and DPST switches CS2 126 and CS3 128 are closed; disconnecting the HV energy storage device 102 from the drive unit 302 while connecting the drive unit 302 to the converting circuit (HB1 130 and HB2 132) and the charging interface 106. In the sourcing mode, the converting circuit (HB1 130 and HB2 132) supplies dc power from the HV energy storage device 102 to the drive unit 302, which delivers ac to the charging interface 106 and the remote load.

Other systems include combinations of some or all of the structure and functions described above and/or shown in one or more or each of the figures. These systems are formed from any combination of structure and function described or illustrated. Some alternative systems interface or propel structures that transport person or things. The system may convert one form of energy into another (e.g., convert a form of energy such as electric energy into mechanical power and/or mechanical power into other forms of energy such as electric energy).

The methods, devices, systems, and logic that control the operation of the electric motor drive systems and its switches described above may be implemented in or may be interfaced in many other ways in many different combinations of hardware, software or both. All or parts of the control system (e.g., the ECU, ECM, PCM, etc.) may be executed through one or more controllers, one or more microprocessors (CPUs), one or more signal processors (SPU), one or more application specific integrated circuit (ASIC), one or more programmable media or combinations of such hardware. All or part of the control systems may he implemented as instructions stored on a non-transitory medium executed by a CPU/SPU/ASIC that comprises electronics including input/output interfaces, vehicle sensor inputs, and an up-dateable memory comprising at least a random access memory which is capable of being updated via an electronic medium and which is capable of storing updated information, processors (e.g., CPUs, SPUs, and/or ASICs) controller, an integrated circuit that includes a microcontroller or other processing devices that may execute software stored on a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, includes a specifically programmed non-transitory storage medium and computer readable instructions stored on that medium, which when executed, cause the control system to perform the specially programmed switching operations and biasing functions.

The term “coupled” disclosed in this description may encompass both direct and indirect coupling. Thus, first and second parts are said to be coupled together when they directly contact one another, as well as when the first part couples to an intermediate part which couples either directly or via one or more additional intermediate parts to the second part. The term “substantially” or “about” may encompass a range that is largely, but not necessarily wholly, that which is specified. It encompasses all but a significant amount. When devices or components of the electric drive systems are responsive to events, the actions and/or steps of devices, such as the operations that other devices are performing, necessarily occur as a direct or indirect result of the preceding events and/or actions. In other words, the operations occur as a result of the preceding operations. A device that is responsive to another requires more than an action (i.e., the device's response to) merely follow another action.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. An electrical vehicle system that recharges and sources electrical power in an electric vehicle comprising:
a first drive unit and a second drive unit serially coupled through a direct current bus; and
a converting circuit serially coupled to the first drive unit and the second drive unit and electrically coupled to a high voltage energy source and a low voltage energy source;
where the converting circuit electrically couples the high voltage energy source and the low voltage energy source through an inductive coupling device.

2. The system of claim 1 where the converting circuit comprises a plurality of switching circuits that enable a voltage to be applied across a load in a plurality of directions.

3. The system of claim 2 where the first switching circuit couples the second switching circuit through a primary of a transformer.

4. The system of claim 3 where the primary of the transformer is directly coupled to eight switches.

5. The system of claim 4 where a secondary of the transformer is coupled to the low voltage energy source.

6. The system of claim 5 where the secondary of the transformer is electrically coupled to a converter that is electrically coupled to the low voltage energy source.

7. The system of claim 1 where the first drive unit and the second drive unit each comprise an inverter/converter and an electric drive assembly.

8. The system of claim 1 where the first drive unit and the second drive unit are connected in series.

9. The system of claim 1 where the first drive unit and the second drive unit are switchably connected to the high voltage source and the converting circuit.

10. The system of claim 1 further comprising a controller programmed to charge the high voltage energy source and the low voltage energy source, enable a propulsion force through a plurality of electric drive assemblies, and enable the high voltage energy source or the low voltage energy source to a load remote the electrical vehicle system.

11. The system of claim 1 where the electrical vehicle system is part of a vehicle and the load is remote from the vehicle.

12. The system of claim 1 where first drive unit comprises a first electric drive assembly mechanically coupled to a drive shaft and the second drive unit comprises a second electric drive assembly coupled to a remote rotary power source.

13. The system of claim 12 where the second electric drive assembly comprises a starter configured as a rotary generator and a rotary motor.

14. The system of claim 13 where the first electric drive assembly and the second electric drive assembly each comprises three phase permanent magnetic devices.

15. The system of claim 13 where the first electric drive assembly and the second electric drive assembly each comprises three phase induction motors.

16. The system of claim 13 further comprising a charge interface electrically coupling a neutral node of the first electric drive assembly and the second electric drive assembly.

17. The system of claim 13 where the rotary power source comprises an internal combustion engine.

18. The system of claim 13 where the rotary power source comprises one or more drive shafts.

19. The system of claim 1 where converter circuit generates an alternating current from a first direct current and generates a second direct current from the alternating current.

20. The system of claim 1 where the first drive unit comprises two switches and a second drive unit comprises an electric drive assembly mechanically coupled to an internal combustion engine.

21. An electrical vehicle system that recharges and sources electrical power in an electric vehicle comprising:
a first drive unit comprising two or more inverter/converters coupled to an electric drive systems comprising a plurality of stator windings collocated in slots within the circumference of the electric drive system's frame; and
a converting circuit serially coupled to the first drive unit and electrically coupled to a high voltage energy source and a low voltage energy source;
where the converting circuit electrically couples the high voltage energy source and the low voltage energy source through an isolating device.

22. The system of claim 21 where the stator winding are collocated in common slots.

23. The system of claim 21 where the stator winding are collocated in different slots.
